(19) United States
(12) Patent Application Publication
(10) Pub. No.: US 2010/0148136 A1
(43) Pub. Date: Jun. 17, 2010

(54) Light Diffusing Thermoplastic Resin Composition and Light Diffusion Sheet Thereof

(76) Inventors: Akihito Kawagoshi, Osaka-shi (JP); Shinji Nukui, Osaka-shi (JP); Koji Okada, Osaka-shi (JP); Weijun Zhou, Freeport, TX (US); David Bank, Midland, MI (US)

Correspondence Address: The Dow Chemical Company;Gary C. Cohn, P. O. Box 313, Huntingdon Valley, PA, 19006, US

(21) Appl. No.: 12/600,448

(22) PCT Filed: Jun. 28, 2007
(86) PCT No.: PCT/JP2007/063405

§ 371 Date: Nov. 16, 2009

(51) Int. Cl. F21V 9/06

(52) U.S. Cl. 252/589

(57) ABSTRACT

The present invention provides a light diffusing thermoplastic resin composition comprising polycaprolactone, specific silicone rubber particles, and, when desired, a fluorescent brightening agent, an antioxidant and/or an ultraviolet light absorber. A light diffusion sheet can be obtained by molding the light diffusing thermoplastic resin composition, which has superior light diffusion properties, luminance, mechanical strength, thermal stability and light resistance.

### FIELD OF THE INVENTION

The present invention relates to a light diffusing thermoplastic resin composition with improved light diffusion properties, luminance, mechanical strength, thermal stability and light resistance obtained by mixing polycaprolactone, other transparent thermoplastic resins and silicone rubber particles having a specific construction and also, when desired, a fluorescent brightening agent, an antioxidant and/or an ultraviolet light absorber, and a light diffusing sheet thereof. More particularly, the present invention presents a light diffusing thermoplastic resin composition ideal for use in materials that cover light sources such as, for example, in the light diffusion sheet for direct backlight units and edge light type units for liquid crystal display type televisions, globe boxes of lighting devices, switches for various devices and general applications that require light diffusing properties, and a light diffusion sheet obtained by molding the composition.

### PRIOR ART

Transparent thermoplastic resins transmit light and are used in a broad range of applications in electrical, electronic, OA, automotive and other areas, and resins that deliver the performance demanded in individual applications are selected to suit the applications. When a transparent thermoplastic resin is used, particularly in applications such as direct-typed and edge light typed backlight units for liquid crystal display type televisions, lighting device covers, switches in various devices and the like, the light source is visible since the resin transmits light. Therefore, a material having sufficient light diffusing properties such that it does not reveal the shape of the light source (a lamp) behind a molded resin product without adversely affecting the luminance of the light source as much as possible is being sought.

In the conventional technology, a method in which polymer or inorganic particles with a different index of refraction were added as a dispersed phase to a continuous phase formed using a thermoplastic resin was used for the purpose of imparting light diffusing properties to a transparent thermoplastic resin. In addition, a method to realize desired light diffusion properties by adjusting the refractive index difference between said dispersed phase and the continuous phase or the size of said particles in the dispersed phase has been proposed.

[Reference 1]

Japanese Patent Application Public Disclosure (Kokai) No. S60-184559

[Reference 2]

Japanese Patent Application Public Disclosure (Kokai) No. H03-143950

### Problems to be Solved by the Invention

However, even better light diffusion properties and luminance are being sought. Although various improvements associated with the composition of the light diffusing agent, refractivity, particle shapes, particle sizes and the like have been investigated, the optical performance realized is determined by the light diffusion agent added, and circumstances make achieving the level of optical performance demanded by modifying the light diffusion agent difficult. Simultaneously, a reduction in the thickness of light diffusion sheets due to the demand for thinner said units, lower production cost and the like is needed in a light diffusion sheet, particularly in the light diffusion sheet used in direct-typed backlight units for large liquid crystal display type televisions, and a light diffusion sheet with a mechanical strength responsive to the needs is being sought. In addition, light diffusion sheets that display bright colors but also possess a level of thermal stability that inhibits color changes (yellowing) in a thermoplastic resin during mold processing with accompanying poor appearance in molded resin products and exceptional light resistance that inhibits discoloration in molded resin products upon exposure to light sources are being sought when desired.

### Means to Solve the Problems

The inventors conducted an extensive study on such problems and developed a light diffusing thermoplastic resin composition comprising polycaprolactone, specific silicone rubber particles, and, when desired, a fluorescent brightening agent, an antioxidant and/or an ultraviolet light absorber. The present invention also found that a light diffusion sheet can be obtained by molding the light diffusing thermoplastic resin composition, which has superior light diffusion properties, luminance, mechanical strength, thermal stability and light resistance.

That is, the first subject of the present invention is a light diffusing thermoplastic resin composition comprising 100 parts by weight of a resin component and 0.1 to 1.5 parts by weight of (C) silicone rubber particles having 0.5 μm to 10 μm of the average particle size, wherein the resin component consists of 0.1% to 7% by weight of (A) polycaprolactone and 93% to 99.9% by weight of (B) other transparent thermoplastic resins, and the (C) silicone rubber particles have a framework structure containing difunctional siloxane units and trifunctional siloxane units and have alkyl groups on the surface.

In addition, the second subject of the present invention is a light diffusing thermoplastic resin composition of the first subject of the present invention, further comprising 0.1 parts or less by weight of (D) a fluorescent brightening agent per 100 parts by weight of the resin component.

In addition, the third subject of the present invention is a light diffusing thermoplastic resin composition of the first or the second subject of the present invention, further comprising 1 part or less by weight of (E) an antioxidant per 100 parts by weight of the resin component.

In addition, the fourth subject of the present invention is a light diffusing thermoplastic resin composition of the first, the second or the third subject of the present invention, further comprising 0.01 parts to 0.8 parts by weight of (F) an ultraviolet light absorber per 100 parts by weight of the resin component.

Furthermore, the present invention is a light diffusing sheet obtained by molding the light diffusing thermoplastic resin compositions described in the first, second, third or fourth subject.

### ADVANTAGES OF THE INVENTION

The light diffusion sheet obtained by molding the light diffusing thermoplastic resin composition of the present invention is ideal for use in a parts material that covers a light source, that is, in diffusing sheets for direct-typed backlight units and edge light-typed backlight units for liquid crystal display type televisions, globe boxes for lighting devices, switches in various devices and applications in general that require light diffusion properties. The light diffusing sheet not only has a high degree of light diffusion properties and optical performance referred to as luminance in addition to excellent thermal stability and light resistance when desired, but also has an extremely excellent utility value in practice since it has a high degree of mechanical strength and can withstand use as a thinner light diffusion sheet.

### BRIEF DESCRIPTION OF THE DRAWINGS

FIG. 1 shows the method used in the present invention for measuring the luminance between lamps. A: Luminance meter; B: Light beams from a lamp; C: Light diffusion sheet; D: Lamps (cold cathode fluorescent tubes)

### DETAILED DESCRIPTION OF THE INVENTION

The polycaprolactone (A) used in the present invention is a polymer prepared using a ring opening polymerization of ε-caprolactone in the present of a catalyst, and the homopolymer of 2-oxepanone is exceptionally ideal. Said polymer is commercially available from The Dow Chemical Co. as Tone Polymer and from Solvay Co. as CAPA and the like. As the viscosity average molecular weight of the polycaprolactone (A), from 10,000 to 100,000 is ideal and 40,000 to 90,000 is more preferred.

Furthermore, the polycaprolactone (A) also includes those polymers obtained by modifying the polymer by having 1,4-butanediol and the like present during a ring opening polymerization of ε-caprolactone and modified polycaprolactones having molecular terminals substituted with ether or ester groups.

The content of the polycaprolactone (A) is from 0.1% by weight to 7% by weight based on resin components (A) and (B), (B) comprising other transparent thermoplastic resins. When the content is less than 0.1% by weight, a light diffusing effect is hardly obtained and sufficient luminance cannot be obtained, making this option unfavorable. Similarly, when the content exceeds 7% by weight, sufficient thermal stability and mechanical strength cannot be obtained making this option unfavorable. A more favored content is from 0.3% by weight to 5% by weight.

As the transparent thermoplastic resin (B) used in the present invention, polycarbonate resins; poly(methyl methacrylate); polystyrene and styrene type copolymers such as acrylonitrile-styrene copolymer, methacrylate-styrene copolymers, acrylonitrile-butadiene-styrene copolymers and the like; polyesters; poly(ether imides); polyimides; polyamides; modified poly(phenylene ether); polyarylates; cycloolefin polymers; polymer alloys obtained by blending polycarbonates with polyesters and the like may be cited. Polycarbonate resins, poly(methyl methacrylate), methyl methacrylate-styrene copolymers, polyarylates, styrene type copolymer resins and cycloolefin polymers can be ideally used. Now, the extent of clarity in a thermoplastic resin (B) allows an observer to recognize an object when a molded material of said resin is placed between an observer and an object such as a light source and the like.

The polycarbonate resin used in the present invention is a polymer that can be obtained using a phosgene method wherein various dihydroxy diaryl compounds and phosgene are allowed to react or using a transesterification method wherein a dihydroxy diaryl compound and a carbonate ester such as diphenyl carbonate and the like are allowed to react. As a typical example, polycarbonate resins produced using 2,2-bis(4-hydroxyphenyl) propane (bisphenol A) can be cited.

As the dihydroxy diaryl compound described above, bis(hydroxyaryl) alkanes such as bis(4-hydroxyphenyl)methane, 1,1-bis(4-hydroxyphenyl)ethane, 2,2-bis(4-hydroxyphenyl) butane, 2,2-bis(4-hydroxyphenyl) octane, bis(4-hydroxyphenyl)phenyl methane, 2,2-bis(4-hydroxyphenyl-3-methylphenyl) propane, 1,1-bis(4-hydroxy-3-tertiary-butylphenyl) propane, 2,2-bis(4-hydroxy-3-bromophenyl) propane, 2,2-bis(4-hydroxy-3,5-dibromophenyl) propane and 2,2-bis(4-hydroxy-3,5-dichlorophenyl) propane; bis(hydroxyaryl)cycloalkanes such as 1,1-bis(4-hydroxyphenyl)cyclopentane and 1,1-bis(4-hydroxyphenyl)cyclohexane; dihydroxy diaryl ethers such as 4,4′-dihydroxy diphenyl ether and 4,4′-dihydroxy-3,3′-dimethyldiphenyl ether; dihydroxy diaryl sulfides such as 4,4′-dihydroxy diphenyl sulfide; dihydroxy diaryl sulfoxides such as 4,4′-dihydroxy diphenyl sulfoxide and 4,4′-dihydroxy-3,3′-dimethyl diphenyl sulfoxide and dihydroxy diaryl sulfones such as 4,4′-dihydroxy diphenyl sulfone and 4,4′-dihydroxy-3,3′-dimethyl diphenyl sulfone and the like may be cited in addition to bisphenol A. They may be used individually or as a mixture of at least two types. In addition to these examples, piperazine, bipiperidyl hydroquinone, resorcinol, 4,4′-dihydroxydiphenyl and the like may be mixed and used.

Furthermore, the dihydroxy diaryl compounds described above and phenol compounds with at least three valences such as those shown below may be mixed and used. As the phenol with at least three valences, fluoroglucine, 4,6-dimethyl-2,4,6-tri-(4-hydroxyphenyl)-heptane, 2,4,6-dimethyl-2,4,6-tri-(4-hydroxyphenyl)-heptane, 1,3,5-tri-(4-hydroxyphenyl)-benzol, 1,1,1-tri-(4-hydroxyphenyl)-ethane and 2,2-bis-[4,4-(4,4′ dihydroxydiphenyl)-cyclohexyl]-propane and the like may be cited.

The viscosity average molecular weight of the polycarbonate resin is ordinarily 10,000 to 100,000, but 15,000 to 35,000 is preferred and 17,000 to 28,000 is more preferred. When producing such a polycarbonate resin, a molecular weight adjusting agent, a catalyst and the like may be used as needed.

The silicone rubber particles (C) used in the present invention are constructed from a framework of difunctional siloxane units shown below by the chemical formula 1 and trifunctional siloxane units shown below by the chemical formula 2, and, in addition, alkyl groups are present on the particle surface.

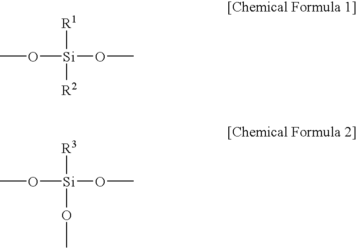

In the chemical formulae 1 and 2, R¹, R² and R³ may be identical to or different from each other and are alkyl groups.

A ratio of the difunctional siloxane units in the framework structure constituting silicone rubber particles (C) of the present invention of from 30% by weight to 95% by weight is preferred, and a range from 40% by weight to 70% by weight is more preferred. The glass transition temperature (Tg) of the silicone rubber declines and the refractivity declines as the ratio of the difunctional siloxane units increases.

In addition, the trifunctional siloxane units are preferably present in from 5% by weight to 70% by weight per siloxane units constituting silicone rubber particles (C), and the range from 30% by weight to 60% by weight is more preferred. The trifunctional siloxane units are used to form a crosslinking structure in the silicone rubber, and their presence yields a potential for the refractivity to rise.

The silicone rubber particles (C) of the present invention can be prepared using a well known method. First of all, the framework can be prepared as described, for example, in “Synthesis and Applications of Organic Silicone Polymers” (published by CMC K.K., Nov. 30, 1989) using a method in which difunctional and trifunctional chlorosilanes or alkoxysilanes are co-hydrolyzed and co-condensed. R¹, R² and R³ can be decided by selecting the alkyl group bonded directly to Si in the chlorosilane or alkoxysilane used at this point. Of the groups, alkyl groups having 1 to 6 carbon atoms are preferred and the methyl group is more preferred.

The ratio of difunctional siloxane units to trifunctional siloxane units may be selected according to the Tg and refractivity of the desired silicone rubber particles (C). Now silicone rubber particles (C) with a Tg from −50° C. to −200° C. are suited. A refractivity of from 1.39 to 1.46 is suited.

The average particle size of the silicone rubber particles (C) of the present invention is from 0.5 μm to 10 μm. When the average particle size is less than 0.5 μm, sufficient light diffusion properties are not displayed, making this option unfavorable. In addition, when the average particle size exceeds 10 μm, the transmitted light declines, making this option unfavorable. The average particle size is preferably in the range of from 2 μm to 4 μm.

Such silicone rubber particles are commercially available as “Trefil E-600” and “Trefil E-606” from Toray-Dow Corning Silicone Co., Ltd.

The amount of silicone rubber particles (C) added is from 0.1 parts by weight to 1.5 parts by weight (per 100 parts by weight of a resin component comprising 0.1% by weight to 7% by weight of polycaprolactone (A) and from 93% by weight to 99.9% by weight of other transparent thermoplastic resins (B)). When the amount added is less than 0.1 parts by weight, a sufficient light diffusing effect is difficult to attain and sufficient mechanical strength cannot be obtained, making this option unfavorable. Similarly, when the amount exceeds 1.5 parts by weight, the light transmittance is adversely affected and sufficient light diffusing performance cannot be achieved, making this option unfavorable. The range from 0.5 parts by weight to 1.2 parts by weight is more preferred.

Furthermore, 0.1 parts or less by weight (per 100 parts by weight of a resin component comprising 0.1% by weight to 7% by weight of polycaprolactone (A) and from 93% by weight to 99.9% by weight of other transparent thermoplastic resins (B)) of a fluorescent brightening agent (D) may also be added to a light diffusing thermoplastic resin composition of the present invention comprising (A), (B) and (C) in order to obtain brighter colors. When the amount added exceeds 0.1 parts by weight, thermal stability declines, making this option unfavorable. A more preferred amount added is 0.03 parts or less. Some types of thermoplastic resins absorb some blue light and tend to be somewhat yellowish. When a compound (fluorescent brightening agent) that emits blue or purple fluorescent light that complements the yellow is added, bright colors can be obtained due to the fluorescent light cancelling the yellow. A fluorescent brightening agent absorbs the energy in the ultraviolet region and releases the energy associated with the visible region corresponding to the wavelengths from blue to purple. By using a fluorescent brightening agent in combination, far brighter colors can be obtained while retaining the light diffusing performance.

As the antioxidant (E) used in the present invention, phosphite type antioxidants, phosphate type antioxidants, phosphonite type antioxidants and ester type antioxidants thereof may be cited. Of the antioxidants (E), cyclic phosphite ester type compounds prepared by allowing phenols or bisphenols, phosphorus trihalides and amine compound to react are particularly preferred. As the reaction method, an intermediate is ordinarily formed first by allowing phenols or bisphenols and phosphorus trihalide to react, and the intermediate is subsequently allowed to react with an amine compound in a two stage reaction process. The reaction is ordinarily allowed to occur in an organic solvent at from 0° C. to 200° C. 2,4,8,10-tetra-t-Butyl-6-[3-(3-methyl-4-hydroxy-5-t-butylphenyl) propoxy] dibenzo[d,f][1,3,2]dioxaphosphepin is exceptionally ideal, and Sumilizer GP manufactured by Sumitomo Chemical Co. can be cited as a commercial product.

The amount of the antioxidant (E) added is 1 part or less by weight (per 100 parts by weight of a resin component comprising 0.1% by weight to 7% by weight of polycaprolactone (A) and from 93% by weight to 99.9% by weight of other transparent thermoplastic resins (B)). When the amount added exceeds 1 part by weight, resin degradation is accelerated and sufficient mechanical strength cannot be obtained, making this option unfavorable. The range of from 0.05 parts by weight to 0.6 parts by weight is preferred.

As the ultraviolet light absorber (F) used in the present invention, benzophenone type ultraviolet light absorbers, benzotriazole type ultraviolet light absorbers, triazine type ultraviolet light absorbers, malonic acid ester type ultraviolet light absorbers and oxalanilide type ultraviolet light absorbers may be cited. These ultraviolet light absorbers may be used individually or in a combination of at least two. Of the ultraviolet light absorbers (F), those with a structure containing alkyl groups and alkoxy groups symmetrically substituted on the two nitrogen atoms in the oxanilide framework, which is represented by a chemical formula below, are ideally used. N-(2-Ethylphenyl)-N′-(2-ethoxyphenyl) oxalic acid diamide is exceptionally ideal. As commercially available products, Sanduvor VSU, manufactured by Clariant Japan Co., and the like may be cited.

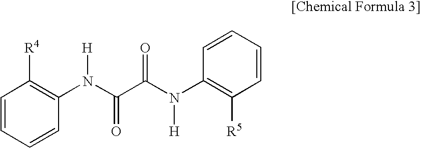

In the formula, R⁴ is an alkyl group with 1 to 12 carbon atoms and R⁵ is an alkoxy group with 1 to 12 carbon atoms.

The amount of the ultraviolet light absorber (F) added is from 0.01 parts by weight to 0.8 parts by weight (per 100 parts by weight of a resin component comprising 0.1% by weight to 7% by weight of polycaprolactone (A) and from 93% by weight to 99.9% by weight of other transparent thermoplastic resins (B)). When the amount added is less than 0.01 parts by weight, sufficient light resistance is not obtained, making this option unfavorable. Similarly, when the amount added exceeds 0.8 parts by weight, thermal stability declines, making this option unfavorable. The range from 0.05 parts by weight to 0.6 parts by weight is more preferred.

In addition, a variety of well known flame retardants may be added when flame retardance is needed. As to the variety of flame retardants, bromine type flame retardants such as tetrabromobisphenol A oligomers and the like; monophosphate esters such as triphenyl phosphate, tricresyl phosphate and the like; oligomer type condensed phosphate esters such as bisphenol A diphosphate, resorcinol diphosphate, tetraxylenyl resorcinol diphosphate and the like; phosphorus type flame retardants such as ammonium polyphosphate, red phosphorus and the like; various silicone type flame retardants and aromatic sulfonic acid metal salts and perfluoroalkane sulfonic acid metal salts used to enhance flame retardance, for example, may be cited. Ideally, organic metal salts such as 4-methyl-N-(4-methylphenyl) sulfonylbenzene sulfonamide potassium salt, potassium diphenylsulfone-3-sulfonate, sodium para-toluenesulfonate, potassium perfluorobutane sulfonate and the like may also be added.

In addition to the well known additives listed above, lubricants (paraffin wax, n-butyl stearate, synthetic beeswax, natural beeswax, glycerin monoesters, montan acid wax, polyethylene wax, pentaerythritol tetrastearate and the like), coloring agents (titanium oxide, carbon black and dyes, for example), fillers (calcium carbonate, clay, silica, glass fibers, glass spheres, glass flakes, carbon fibers, talc, mica, various whiskers and the like), flow modifiers, developing agents (epoxidized soy bean oil, fluid paraffin and the like), other thermoplastic resins and various impact modifiers (rubber reinforced resins obtained by graft polymerization of compounds such as methacrylate esters, styrene, acrylonitrile and the like on a rubber such as polybutadiene type rubber, poly(acrylate ester) rubber, ethylene-propylene type rubber and the like can be listed as examples), for example, may be added as needed to the light diffusing thermoplastic resin composition of the present invention.

The order in which the present invention is executed is not restricted at all. For example, a method in which polycaprolactone (A), transparent thermoplastic resin (B) and silicone rubber particles (C) as well as a fluorescent brightening agent (D), an antioxidant (E) and/or an ultraviolet light absorber (F) are measured in optional amounts, mixed using any of a tumbler, ribbon blender, high speed mixer and the like and the mixture is subsequently melted and compounded using an ordinary single or twin screw extruder to form pellets; a method in which a portion or all of the individual components are separately measured, added to an extruder from multiple numbers of supply devices and melted and kneaded; and, furthermore, a method in which high concentrations of (A) and (C), (D), (E) and/or (F) are added, melted and mixed once to form pellets of a master batch and said master batch obtained is subsequently mixed in a desired proportion with (B) may be used. When melting and mixing these components, the conditions such as the addition locations in the extruder, extrusion temperature, screw rotation rate, amount supplied and the like are optionally selected according to the circumstances for the pellet formation. Furthermore, said master batch and (B) may be mixed dry according to a desired proportion and subsequently added directly to an injection molding machine or a sheet extrusion machine to obtain molded products. In addition, the method with which the light diffusing thermoplastic resin composition of the present invention is molded is not particularly restricted, and well known injection molding methods, injection compression molding methods, extrusion molding methods and the like may be used.

### EXAMPLES

The present invention is explained below using examples, but the present invention is not limited to these examples. Now, the terms “%” and “parts” used in the examples both refer to weight standards unless otherwise stated.

The starting materials used are described below.

### Polycaprolactone:

CAPA6500C manufactured by Solvay Corp. (Viscosity average molecular weight: 50,000. Henceforth abbreviated to PCL.)

### Polycarbonate Resin:

Sumitomo Dow Limited, Calibre 200-13 (viscosity average molecular weight: 25,000, henceforth abbreviated to “PC”).

### Silicone Rubber Particles:

Toray-Dow Corning Silicone Co., Trefil E-606 (dimethyl polysiloxane, henceforth abbreviated to “LD-1”).
Toray-Dow Corning Silicone Co., Trefil E-601 (epoxy modified dimethyl polysiloxane, henceforth abbreviated to “LD-2”).

### Acrylic Light Diffusion Agent:

Rohm and Haas Corp., EXL-5136 (henceforth abbreviated to “LD-3”)

### Fluorescent Brightening Agent:

HOSTALUX KSN manufactured by Clariant Japan Co. (henceforth abbreviated to “FWA”).

### Antioxidant:

Sumilizer GP manufactured by Sumitomo Chemical Co. (a cyclic phosphite ester type antioxidant, henceforth abbreviated to “AO”).

### Ultraviolet Light Absorber:

Sanduvor VSU manufactured by Clariant Japan Co. (an oxalanilide type ultraviolet light absorber, henceforth abbreviated to “UVA”).

The measurements used to evaluate various properties for the present invention are explained.

### 1. Luminance Measurements

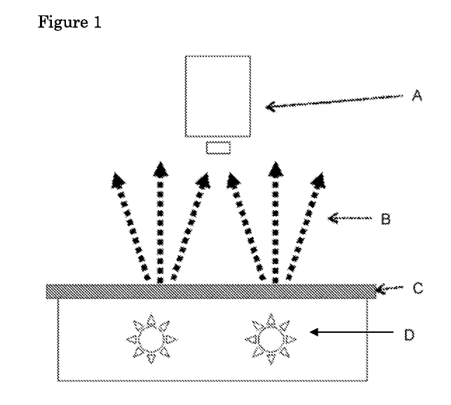

Two cold cathode fluorescent tubes were placed behind test plaques (90 mm long 50 mm wide and 2 mm thick) prepared using an injection molding machine, and the luminance of the test plaque surface in the direction perpendicular to the lamps was measured. Now, the luminance refers to the ratio of the luminosity in one direction to the luminosity per unit area in a surface perpendicular to the direction. In general, it represents the brightness of a light emitting surface (unit: (cd/m²)). In addition, as the evaluation standard, those having brightness between lamps values of at least 3,225 cd/m² passed (O) and those having less than 3,225 cd/m² failed (X). The measurement method is roughly diagramed in FIG. 1.

### 2. Color

Test plaques prepared using an injection molding machine were used and b* was measured using a CMS-35SP spectrophotometer manufactured by Murakami Color Research Laboratory Co. b* represents the extent of blue from yellow. The smaller the b*, the less yellow and more blue are observed. According to the evaluation standards, those with b* values less than −5.0 passed (O), and those with b*values of −5.0 or greater failed (X).

### 3. Mechanical Strength

Notched Izod test pieces (6.3 mm long, 1.3 mm wide and ⅛ inch thick) prepared using an injection molding machine according to ASTM D-256 specifications were used, and the mechanical strength (impact strength) was measured using an Izod testing device manufactured by Toyo Seiki Co. According to the evaluation standards, those with an impact strength of at least 45 kg·cm/cm passed (O), and those with an impact strength less than 45 kg·cm/cm failed.

### 4. Thermal Stability

Test plaques were prepared using an injection molding machine at a cylinder set temperature of 320° C. and about fifteen minutes of residence time. The change (ΔYI) in the degree of yellowness was evaluated with a spectrophotometer (CMS-35SP manufactured by Murakami Color Research Laboratory Co.). The ΔYI represents the difference in the extent of yellowness before and after the residence time. The smaller the ΔYI, the less extensive the discoloration, indicating excellent light resistance. According to the standards for ΔYI evaluation, those with a ΔYI of less than 4.5 passed (O) and those with a ΔYI of 4.5 or greater failed (X).

### 5. Light Resistance

Test plaques (30 mm long×30 mm wide and 2 mm thick) prepared using an injection molding machine were used and irradiated for six hours using an Eye Super UV Tester (SUV-W13 manufactured by Iwasaki Electric Co.), a super accelerated weathering device. The sample was subsequently examined using a spectrophotometer (CMS-35SP manufactured by Murakami Color Research Laboratory Co.) to measure the change (ΔYI) in the degree of yellowness. The ΔYI represents the difference in the extent of yellowness before and after irradiation. The smaller the ΔYI, the less the color change indicating excellent light resistance. According to the standards for ΔYI evaluation, those with a ΔYI of less than twelve passed (O) and those with a ΔYI of twelve or greater failed (X).

### 6. Overall Rating

Tables 1, 2 and 4, below, report those examples that met all the requirements of luminance between lamps, mechanical strength and thermal stability as passed (O) and those that did not meet the requirements as failed (X). In Table 3, the luminance between lamps, mechanical strength, thermal stability and color evaluation results are reported. Those that met all the requirements passed (O) and those that did not meet the requirements failed (X). In Table 5, the luminance between lamps, mechanical strength, thermal stability and light resistance evaluation results are reported. Those that met all the requirements passed (O) and those that did not meet the requirements failed (X).

Various components were dry blended using a tumbler according to the formulation components and proportions shown in Tables 1 through 5. Next, the mixtures were compounded using a twin screw extruder (TEX-30 α manufactured by Japan Steel Works Steel Limited, diameter 30 mmΦ and L/D=41) at a temperature of from 250° C. to 290° C. Various pellets obtained were converted into test plaques 90 mm long, 50 mm wide and 2 mm thick and into Sharpy test pieces according to ISO specifications using an injection molding machine (J100E2P manufactured by The Japan Steel Works Limited) at a cylinder set temperature of 300° C. Now, test plaques 90 mm long, 50 mm wide and 2 mm thick were prepared for the purpose of evaluating thermal stability using an injection molding machine (J100E2P manufactured by The Japan Steel Works Limited) at a cylinder set temperature of 320° C. after a residence time of fifteen minutes. The measurements and evaluation results are shown in Tables 1 to 5.

TABLE 1

| | Example | Example | Example | Example | Example |
|---|---|---|---|---|---|
| | 1 | 2 | 3 | 4 | 5 |
| PCL (parts) | 3.0 | 0.3 | 5.0 | 3.0 | 3.0 |
| PC (parts) | 97.0 | 99.7 | 95.0 | 97.0 | 97.0 |
| LD-1 (parts) | 0.5 | 0.5 | 0.5 | 0.3 | 1.0 |
| Luminance between | 3310 | 3290 | 3350 | 3330 | 3250 |
| lamps (cd/m2) | | | | | |
| Rating | ∘ | ∘ | ∘ | ∘ | ∘ |
| Mechanical strength | 55 | 85 | 46 | 49 | 67 |
| (kg · cm/cm) | | | | | |
| Rating | ∘ | ∘ | ∘ | ∘ | ∘ |
| Thermal stability | 3.1 | 3.0 | 3.8 | 2.4 | 4.0 |
| (Δ YI) | | | | | |
| Rating | ∘ | ∘ | ∘ | ∘ | ∘ |
| Overall rating | ∘ | ∘ | ∘ | ∘ | ∘ |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| PCL (parts) | 0.05 | 10.0 | 3.0 | 3.0 | 3.0 | 3.0 |
| PC (parts) | 99.95 | 90.0 | 97.0 | 97.0 | 97.0 | 97.0 |
| LD-1 (parts) | 0.5 | 0.5 | 0.05 | 3.0 | — | — |
| LD-2 (parts) | — | — | — | — | 0.5 | — |
| LD-3 (parts) | — | — | — | — | — | 3.0 |
| Luminance between | 3210 | 3380 | 3140 | 3090 | 3300 | 3230 |
| lamps (cd/m2) | | | | | | |
| Rating | x | ∘ | x | x | ∘ | ∘ |
| Mechanical strength | 75 | 17 | 42 | 92 | 73 | 8 |
| (kg · cm/cm) | | | | | | |
| Rating | ∘ | x | x | ∘ | ∘ | x |
| Thermal stability | 2.8 | 5.2 | 1.9 | 4.4 | 8.5 | 6.2 |
| (Δ YI) | | | | | | |
| Rating | ∘ | x | ∘ | ∘ | x | x |
| Overall rating | x | x | x | x | x | x |

TABLE 3

| | Example | Comparative |
|---|---|---|
| | 6 | Example 7 |
| PCL (parts) | 3.0 | 3.0 |
| PC (parts) | 97.0 | 97.0 |
| LD-1 (parts) | 0.5 | 0.5 |
| FWA (parts) | 0.01 | 0.3 |
| Luminance between | 3300 | 3270 |
| tamps (cd/m2) | | |
| Rating | ∘ | ∘ |
| Mechanical strength | 55 | 53 |
| (kg · cm/cm) | | |
| Rating | ∘ | ∘ |
| Thermal stability | 3.2 | 4.6 |
| (Δ YI) | | |
| Rating | ∘ | x |
| Color (b*) | −7.8 | −18.4 |
| Rating | ∘ | ∘ |
| Overall rating | ∘ | x |

TABLE 4

| | Example | Comparative |
|---|---|---|
| | 7 | Example 8 |
| PCL (parts) | 3.0 | 3.0 |
| PC (parts) | 97.0 | 97.0 |
| LD-1 (parts) | 0.5 | 0.5 |
| AO (parts) | 0.2 | 3.0 |
| Luminance between | 3300 | 3260 |
| lamps (cd/m2) | | |
| Rating | ∘ | ∘ |
| Mechanical strength | 55 | 8 |
| (kg · cm/cm) | | |
| Rating | ∘ | x |
| Thermal stability | 1.9 | 1.5 |
| (Δ YI) | | |
| Rating | ∘ | ∘ |
| Overall rating | ∘ | x |

TABLE 5

| | Example | Example | Comparative | Comparative |
|---|---|---|---|---|
| | 8 | 9 | Example 9 | Example 10 |
| PCL (parts) | 3.0 | 3.0 | 3.0 | 3.0 |
| PC (parts) | 97.0 | 97.0 | 97.0 | 97.0 |
| LD-1 (parts) | 0.5 | 0.5 | 0.5 | 0.5 |
| UVA (parts) | 0.05 | 0.6 | 0.005 | 3.0 |
| Luminance between | 3300 | 3270 | 3310 | 3250 |
| lamps (cd/m2) | | | | |
| Rating | ∘ | ∘ | ∘ | ∘ |
| Mechanical strength | 55 | 52 | 56 | 50 |
| (kg · cm/cm) | | | | |
| Rating | ∘ | ∘ | ∘ | ∘ |
| Thermal stability | 3.2 | 2.1 | 2.3 | 6.0 |
| (Δ YI) | | | | |
| Rating | ∘ | ∘ | ∘ | x |
| Light Resistance | 8.4 | 0.6 | 15.3 | 0.1 |
| (Δ YI) | | | | |
| Rating | ∘ | ∘ | x | ∘ |
| Overall rating | ∘ | ∘ | x | x |

As shown in Tables 1 to 5, adequate performance was observed in all of the evaluated properties when the constitution of the present invention was satisfied

(Examples 1 to 9). As demonstrated in Example 6, the color improved when a fluorescent brightening agent was added in the amount specified. In addition, as shown in Example 7, the thermal stability improved when an antioxidant was added in the amount specified. Furthermore, the light resistance improved as shown in Examples 8 and 9 when an ultraviolet light absorber was added in the amount specified.

Similarly, some deficiencies were encountered in all cases when the constitution of the present invention was not satisfied as indicated by the results reported in Tables 2 to 5.

The amount of polycaprolactone added was less than the amount specified in Comparative Example 1, and the luminance between lamps was poor although the mechanical strength and thermal stability were acceptable.

The amount of polycaprolactone added was greater than the amount specified in Comparative Example 2, and the mechanical strength and thermal stability were poor although the luminance between lamps was acceptable.

The amount of silicone rubber particles containing methyl groups added was less than the amount specified in Comparative Example 3, and the luminance between lamps and mechanical strength were poor although the thermal stability was acceptable.

The amount of silicone rubber particles containing methyl groups added was greater than the amount specified in Comparative Example 4, and the luminance between lamps was poor although the mechanical strength and thermal stability were acceptable.

Silicone rubber particles containing epoxy groups were used in Comparative Example 5, and the thermal stability was poor although the luminance between lamps and mechanical strength were acceptable.

An acrylic light diffusion agent was used in Comparative Example 6, and the mechanical strength and thermal stability were poor although the luminance between lamps was acceptable.

The amount of the fluorescent brightening agent added was greater than the amount specified in Comparative Example 7, and the thermal stability was poor although the luminance between lamps and mechanical strength were acceptable.

The amount of the antioxidant added was greater than the amount specified in Comparative Example 8, and the mechanical strength was poor although the luminance between lamps and mechanical strength were acceptable.

The amount of the ultraviolet light absorber added was less than the amount specified in Comparative Example 9, and the light resistance was poor although the luminance between lamps, mechanical strength and thermal stability were acceptable.

The amount of the ultraviolet light absorber added was greater than the amount specified in Comparative Example 10, and the thermal stability was poor although the luminance between lamps, mechanical strength and light resistance were acceptable.

1. A light diffusing thermoplastic resin composition comprising 100 parts by weight of a resin component and 0.1 to 1.5 parts by weight of (C) silicone rubber particles having 0.5 μm to 10 μm of the average particle size, wherein the resin component consists of 0.1% to 7% by weight of (A) polycaprolactone and 93% to 99.9% by weight of (B) other transparent thermoplastic resins, and the (C) silicone rubber particles have a framework structure containing difunctional siloxane units and trifunctional siloxane units and have alkyl groups on the surface.

2. The light diffusing thermoplastic resin composition of claim 1 wherein the viscosity average molecular weight of (A) polycaprolactone is 40,000 to 90,000.

3. The light diffusing thermoplastic resin composition of claim 1 wherein the content of (A) polycaprolactone is 0.3% to 5% by weight.

4. The light diffusing thermoplastic resin composition of claim 1 wherein the (B) transparent thermoplastic resin is at least one resin selected from the group consisting of polycarbonate resins, poly(methyl methacrylate), methyl methacrylate-styrene copolymers, polyarylate, polystyrene, styrene type copolymer resins and cycloolefin polymers.

5. The light diffusing thermoplastic resin composition of claim 1 wherein the alkyl groups on the surface of the (C) silicone rubber particles are methyl groups.

6. The light diffusing thermoplastic resin composition of claim 1 wherein the average particle size of the (C) silicone rubber particles is from 2 μm to 4 μm.

7. The light diffusing thermoplastic resin composition of claim 1 wherein the amount of the (C) silicone rubber particles is 0.5 parts to 1.2 parts by weight per 100 parts by weight of the resin component.

8. The light diffusing thermoplastic resin composition of claim 1 further comprising 0.1 parts or less by weight of (D) a fluorescent brightening agent per 100 parts by weight of the resin component.

9. The light diffusing thermoplastic resin composition of claim 1 further comprising 1 part or less by weight of (E) an antioxidant per 100 parts by weight of the resin component.

10. The light diffusing thermoplastic resin composition of claim 9 wherein the (E) antioxidant is a cyclic phosphite ester type compound.

11. The light diffusing thermoplastic resin composition of claim 9 wherein the (E) antioxidant is 2,4,8,10-tetra-t-butyl-6-[3-(3-methyl-4-hydroxy-5-t-butylphenyl) propoxy] dibenzo[d,f][1,3,2]dioxaphosphepin.

12. The light diffusing thermoplastic resin composition of claim 1, further comprising 0.01 parts to 0.8 parts by weight of (F) an ultraviolet light absorber per 100 parts by weight of the resin component.

13. The light diffusing thermoplastic resin composition of claim 12 wherein the (F) ultraviolet light absorber is a compound represented by a chemical formula below: 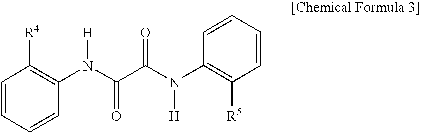
wherein R⁴ is an alkyl group with 1 to 12 carbon atoms and R⁵ is an alkoxy group with 1 to 12 carbon atoms.

14. A light diffusion sheet obtained by molding the light diffusing thermoplastic resin composition of claim 1.
